(19) United States
(12) Patent Application Publication
(10) Pub. No.: US 2011/0150666 A1
(43) Pub. Date: Jun. 23, 2011

(54) TURBINE BLADE

(76) Inventors: BRIAN THOMAS HAZEL, Cincinnati, OH (US); DOUGLAS GERARD KONITZER, Cincinnati, OH (US); MICHAEL HOWARD RUCKER, Cincinnati, OH (US); JOHN DOULGAS EVANS, SR., Cincinnati, OH (US)

(21) Appl. No.: 12/771,378

(22) Filed: Apr. 30, 2010

Related U.S. Application Data
(60) Provisional application No. 61/287,874, filed on Dec. 18, 2009.

(51) Int. Cl. F01D 5/18; F03B 3/12; B23P 15/02

(52) U.S. Cl. 416/97 R; 416/241 R; 29/889.721

(57) ABSTRACT

A turbine blade having an internal skeleton having a plurality of internal ribs that form a plurality of open cooling channels; an internal environmental coating applied to the internal skeleton; an outer wall applied about the open cooling channels of the internal skeleton to form a near wall circuit of cooling channels; and an external environmental coating applied to the outer wall wherein the internal environmental coating is different from the external environmental coating.

### CROSS REFERENCE TO RELATED APPLICATIONS

This application claims priority to U.S. Provisional Application Ser. No. 61/287,874, filed Dec. 18, 2009, which is herein incorporated by reference in its entirety.

### TECHNICAL FIELD

Embodiments described herein generally relate to turbine blades. More particularly, embodiments described herein generally relate to turbine blades made by using investment casting to make a net shape, complex internal skeleton without the use of cores, followed by the application of an outer wall to create a near wall circuit and complete the turbine blade.

### BACKGROUND OF THE INVENTION

Cast turbine airfoils for advanced gas turbine engines have internal features that can challenge the capability of current casting technologies. The castings require complex ceramic cores to form the internal features and those cores are fragile during the casting process. The result is that casting yields of 50 percent to 70 percent are not uncommon. The 30 percent to 50 percent casting scrap factors into the cost of the useable castings. The issue is compounded by exotic alloys, such as single crystal materials, that can drive up the cost to cast a part, and thus drive up the cost caused by scrapping hardware.

Investment casting results in a blade having internal and external portions fabricated from the same materials. Similarly, because diffusion processes are used to apply environmental coatings to the blade, it is common for internal and external portions of the blade to comprise the same coatings. Such processes do not allow for the manufacturing or coating of internal portion of the blade independently of the external portion.

Accordingly, there remains a need for improved turbine blades, as well as methods for making turbine blades, having complex and efficient cooling schemes that can avoid the previously discussed issues.

### BRIEF DESCRIPTION OF THE INVENTION

Embodiments herein generally relate to turbine blades comprising: an internal skeleton having a plurality of internal ribs that form a plurality of open cooling channels; an internal environmental coating applied to the internal skeleton; an outer wall applied about the open cooling channels of the internal skeleton to form a near wall circuit of cooling channels; and an external environmental coating applied to the outer wall wherein the internal environmental coating is different from the external environmental coating.

Embodiments herein also generally relate to turbine blades comprising: an internal skeleton having: an inner cooling circuit comprising at least one closed cooling channel; and a plurality of internal ribs that form a plurality of open cooling channels; an outer wall applied about the open cooling channels of the internal skeleton to form a near wall circuit of cooling channels; and a plurality of cross-over holes between the cooling channels of the near wall circuit and the closed cooling channels of the inner cooling circuit wherein each cooling channel of the near wall circuit is positioned at least about 10 mils from each of the other cooling channels of the near wall circuit, and from each of the closed cooling channels of the inner cooling circuit.

Embodiments herein also generally relate to turbine blades made by a method comprising: casting an internal skeleton having a plurality of internal ribs that form a plurality of open cooling channels; applying a filler material to the open cooling channels; and applying an outer wall about the internal skeleton having the filler material applied to the open cooling channels.

These and other features, aspects and advantages will become evident to those skilled in the art from the following disclosure.

### BRIEF DESCRIPTION OF THE DRAWINGS

While the specification concludes with claims particularly pointing out and distinctly claiming the invention, it is believed that the embodiments set forth herein will be better understood from the following description in conjunction with the accompanying figures, in which like reference numerals identify like elements.

FIG. 1 is a schematic perspective view of one embodiment of a turbine blade in accordance with the description herein;

FIG. 2 is a schematic cross-sectional view of one embodiment of a turbine blade in accordance with the description herein;

FIG. 3 is a schematic perspective view of one embodiment of an internal skeleton in accordance with the description herein;

FIG. 4 is a top view the embodiment of FIG. 3 having an internal environmental coating and filler material applied to the cooling channels in accordance with the description herein;

FIG. 5 is the embodiment of FIG. 4 after the outer wall has been applied in accordance with the description herein; and

FIG. 6 is the embodiment of FIG. 5 after the filler material has been removed in accordance with the description herein.

### DETAILED DESCRIPTION OF THE INVENTION

Embodiments described herein generally relate to methods for making turbine blades. More particularly, embodiments described herein generally relate to methods for making a turbine blade using investment casting to make a net shape, complex internal skeleton without the use of cores, followed by the application of an outer wall to complete the turbine blade.

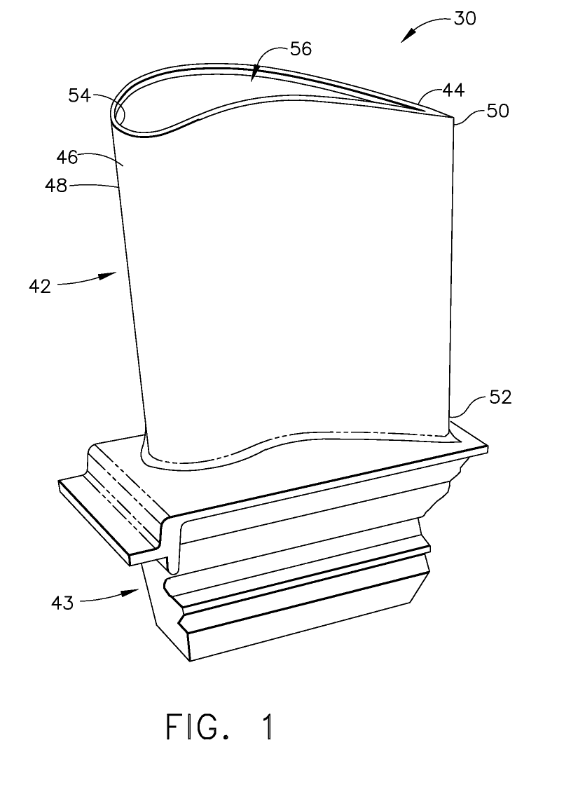

Referring to the drawings wherein identical reference numerals denote the same elements throughout the various views, FIG. 1 shows a conventional turbine blade 30 for use in a turbine engine (not shown). Turbine blade 30 includes a hollow airfoil 42 and an integral dovetail 43 for mounting turbine blade 30 to a turbine disk (not shown) in a known manner. Airfoil 42 includes a first sidewall 44 and a second sidewall 46. First sidewall 44 is convex and defines a suction side of airfoil 42, while second sidewall 46 is concave and defines a pressure side of airfoil 42. Sidewalls 44 and 46 are connected at a leading edge 48 and at an axially spaced trailing edge 50 of airfoil 42.

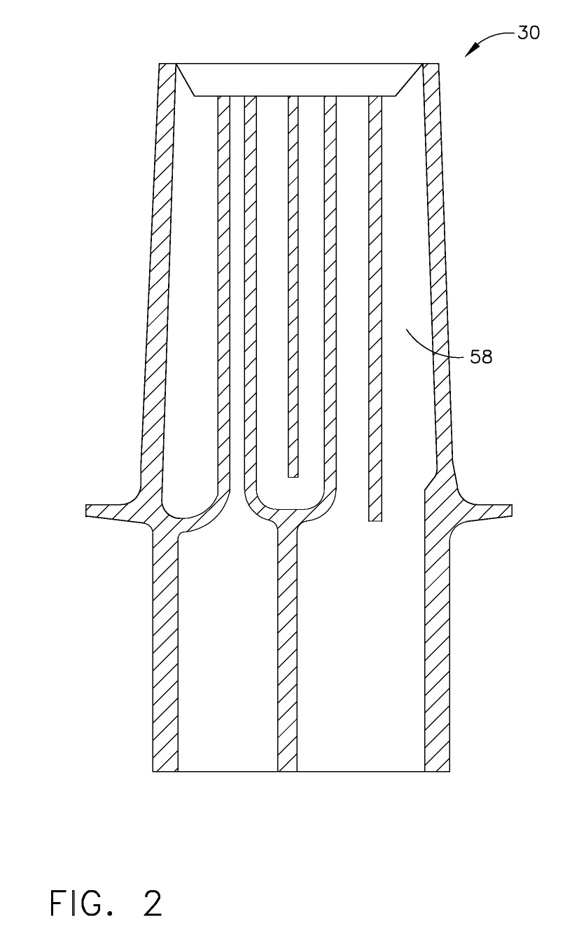

First and second sidewalls 44 and 46, respectively, extend longitudinally or radially outward to span from a blade root 52 positioned adjacent to dovetail 43 to a top plate 54, which defines a radially outer boundary of a cooling circuit 56. Cooling circuit 56 is defined within airfoil 42 between sidewalls 44 and 46, and is known in the art. In the exemplary embodiment, cooling circuit 56 includes a serpentine passage 58, as shown in FIG. 2. Those skilled in the art will understand that the serpentine passage shown herein is but one example of a cooling circuit that can be made using the methods described below. As explained herein, a variety of cooling circuits designs can be fabricated having the below fabrication parameters.

In the embodiments herein, investment casting can be used to make a net shape, complex internal skeleton defining open cooling channels, and optionally additional closed cooling channels. The open cooling channels may then be filled with a filler material and an outer wall applied to close the open cooling channels, as set forth below.

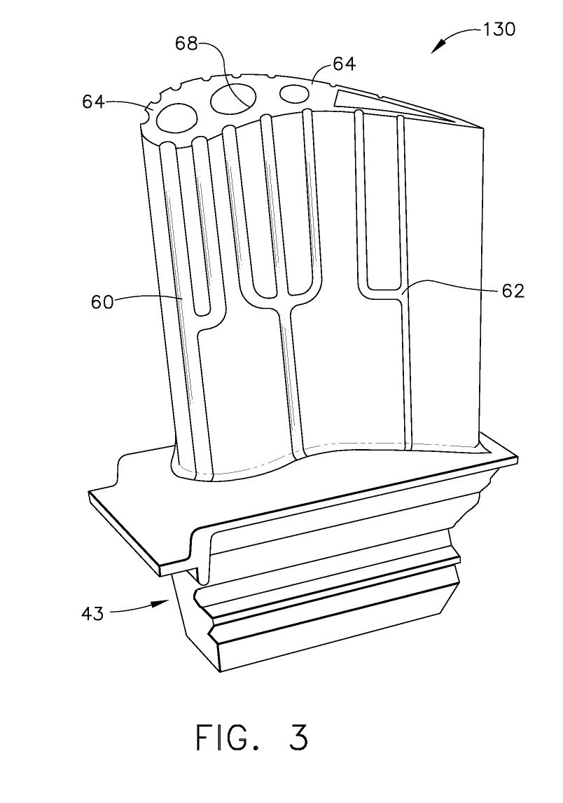

Initially, an internal skeleton 60 as shown in FIG. 3 can be manufactured using conventional investment casting processes and materials. Internal skeleton 60 can be made from any suitable nickel-based superalloy, and can define a plurality of open cooling channels 62 formed by a plurality of internal ribs 40, which together can help make up a near wall circuit once an outer wall is applied in the finished blade as described below. As used herein throughout, “nickel-based superalloy” indicates that the metal substrate comprises a greater percentage of nickel than any other element. In the present instance, nickel-based superalloy can refer to alloys such as, but not limited to, Rene N4, Rene N5, Rene N515, Rene N6, CMSX 4®, CMSX 10®, PWA 1480, PWA 1484, and SC 180. Each open cooling channel 62 may comprise a cross-section of at least about 254 microns (about 10 mils). Open channels 62 may be linear, or have a non-linear, complex shape, and may be oriented in a variety of ways. Optionally, skeleton 60 may also comprise any number of closed cooling channels 68, as shown in FIG. 3. Closed cooling channels 68 can be made using existing investment casting core technology.

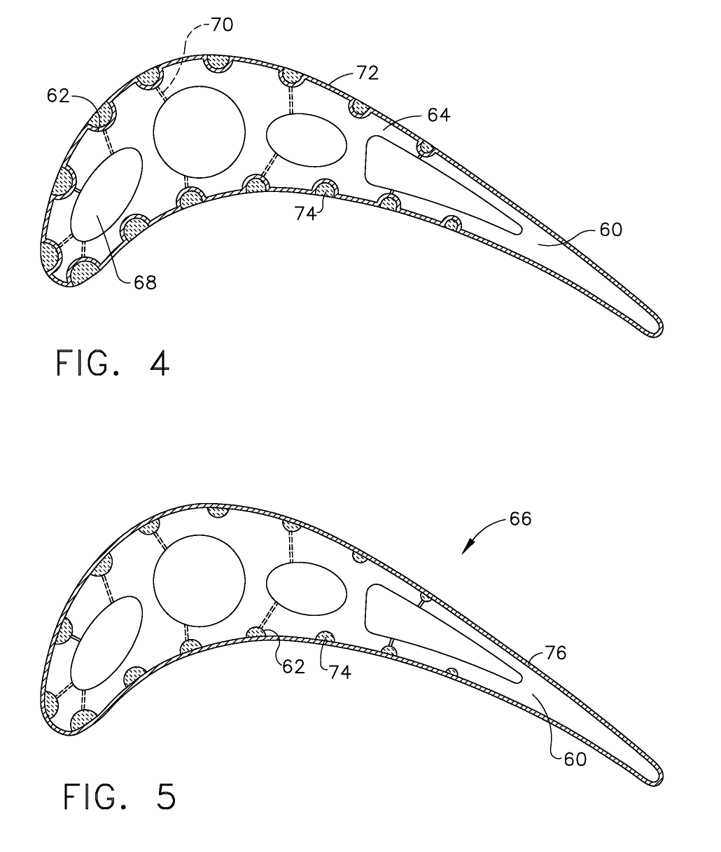

Optionally, following investment casting of internal ribs 64 of internal skeleton 60, a plurality of cross-over holes 70 between open cooling channels 62 and closed cooling channels 68, can be drilled using conventional drilling methods if desired, as shown in FIG. 4.

Internal skeleton 60 can then be optionally coated using any suitable environmental coating material to produce an internal environmental coating 72 on skeleton 60 prior to further processing. An example of a suitable internal environmental coating acceptable for use herein can include, but should not be limited to, diffusion aluminide. The application of internal environmental coating 72 at this point in the process can allow the internal coating to be tailored for optimum blade performance and not limited to the same coating applied to the exterior of the finished blade, as is done currently.

Open cooling channels 62 can be filled with a filler material 74 in preparation of applying the outer wall, as shown in FIG. 4. As used herein, “filler material” refers to any material capable of retaining the geometry of open cooling channels 62 until the outer wall is applied, at which time filler material 74 can be removed from the cooling channels of the near wall circuit using any of a variety of methods, such as chemical digestion, melting, vaporization, or diffusion. Filler material may include, but should not be limited to, aluminum, molybdenum, or polymer. By way of example and not limitation, in one embodiment, filler material may comprise aluminum or polymer, which can later be melted out of the cooling channels of the near wall circuit using conventional techniques at a temperature below the operating temperature of the finished blade. In this way, the filler material could be removed without concern for damaging the blade.

With the cooling channels filled with filler material 74, outer wall 76 can be applied about internal skeleton 60, including open cooling channels 62 having filler material 74, as shown in FIG. 5. Outer wall 76, which can include a plurality of layers of the same, or different, alloy(s), can be applied using a secondary process such as physical vapor deposition (PVD), thermal spraying, cold spraying, or bonding. Specifically, in one embodiment, cathodic arc deposition can be used to apply outer wall 76 about internal skeleton 60 comprising filler material 74. Alternately, a sheet of material can be wrapped about and bonded to internal skeleton 60 using conventional bonding practices to create outer wall 76.

Outer wall 76 can comprise any of a number of materials suitable for use in turbine blade construction, such as the previously set forth nickel-based superalloys. Such materials can be selected to help optimize blade design. For example, in one embodiment, outer wall 76 may comprise a material such as Rene 195, which can provide environmental resistance to the blade. This could allow for a higher strength, lower environmentally resistant material to be used to fabricate the internal skeleton to allow the skeleton to carry the blade loads, but prevent the cost associated with having to apply a separate exterior environmental coating to the finished blade. In another embodiment, outer wall 76 may comprise a material having a lower coefficient of thermal expansion than the material used to make internal skeleton 60 in order to reduce thermal stresses due to through thickness temperature gradients. Outer wall 76 may comprise the same, or different, material from that used to fabricate internal skeleton 60.

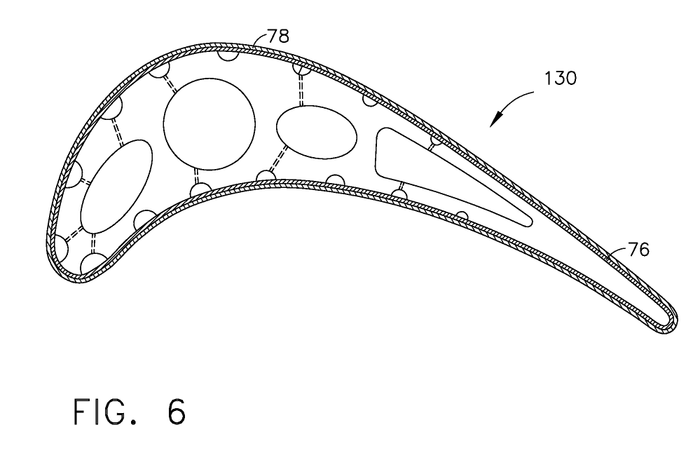

After outer wall is applied, filler material can be removed using any suitable technique as described previously, leaving finished blade 130 having a near wall circuit 66 comprising the formerly open cooling channels 62 and optional closed cooling channels 68, as shown in FIG. 6. Each cooling channel 62 of near wall circuit 66 can be positioned at least about 10 mils from other cooling channels 62 of near wall circuit 66, or from closed cooling channels 68. Outer wall 76 may comprise an external environmental coating 78 selected from diffusion aluminide, platinum modified diffusion aluminide, and MCrAlX overlays. External environmental coating 78 can comprise the same composition as the internal environmental coating (not shown) applied to internal skeleton, or it can be different. Depending on the method of application of the outer wall, the blade may be heat treated to diffusion bond the outer wall to the internal skeleton. Additionally, standard turbine blade manufacturing processes following current investment casting, such as hole drilling, coating, machining, and the like, can then be carried out if needed.

The methods described herein can offer advantages in turbine blade manufacturing. Using the presently described process can allow for two different cooling circuits; the inner cooling circuit, and the near wall circuit defined by the cooling channels and the outer wall. Additionally, the present embodiments can eliminate the use of complex cores in making the near wall circuit, which can result in higher casting yields due to lower core related defects, such as core slip. Moreover, by applying the outer wall as a separate component in the blade fabrication process, it can allow the cooling channels of the near wall circuit to have features as fine as those allowed by conventional investment casting processes (but without the use of cores), as well as a greater degree of freedom in placement. Cross-over holes between the cooling channels and the inner cooling circuit can be drilled that are not possible with conventional casting practices. Such cross-over holes can allow for complex impingement cooling in the near wall circuit, thus further increasing cooling efficiency. Materials used to fabricate the internal skeleton can be selected independently of the materials used to fabricate the outer wall, as can internal environmental coatings be selected independently of external environmental coatings, thereby allowing tailoring of the materials and coatings to optimize blade performance.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A turbine blade comprising:
an internal skeleton having a plurality of internal ribs that form a plurality of open cooling channels;
an internal environmental coating applied to the internal skeleton;
an outer wall applied about the open cooling channels of the internal skeleton to form a near wall circuit of cooling channels; and
an external environmental coating applied to the outer wall
wherein the internal environmental coating is different from the external environmental coating.

2. The blade of claim 1 wherein the internal skeleton comprises a superalloy.

3. The blade of claim 2 wherein the internal skeleton comprises an inner cooling circuit having at least one closed cooling channel.

4. The blade of claim 3 wherein the inner cooling circuit has more than one closed cooling channel.

5. The blade of claim 4 comprising a plurality of cross-over holes between the cooling channels of the near wall circuit and the closed cooling channels of the inner cooling circuit.

6. The blade of claim 5 wherein the internal environmental coating comprises diffusion aluminide and the external environmental coating is platinum modified diffusion aluminide, or MCrAlX overlays.

7. The blade of claim 6 wherein the internal skeleton and the outer wall comprise different superalloy materials.

8. The blade of claim 7 wherein each cooling channel of the near wall circuit is positioned at least about 10 mils from each of the other cooling channels of the near wall circuit, and from each of the closed cooling channels of the inner cooling circuit.

9. A turbine blade comprising:
an internal skeleton having:
an inner cooling circuit comprising at least one closed cooling channel; and
a plurality of internal ribs that form a plurality of open cooling channels;
an outer wall applied about the open cooling channels of the internal skeleton to form a near wall circuit of cooling channels; and
a plurality of cross-over holes between the cooling channels of the near wall circuit and the closed cooling channels of the inner cooling circuit
wherein each cooling channel of the near wall circuit is positioned at least about 10 mils from each of the other cooling channels of the near wall circuit, and from each of the closed cooling channels of the inner cooling circuit.

10. The blade of claim 9 wherein the inner cooling circuit has more than one closed cooling channel.

11. The blade of claim 10 wherein the internal skeleton and the outer wall comprise different superalloy materials.

12. A turbine blade made by a method comprising:
casting an internal skeleton having a plurality of internal ribs that form a plurality of open cooling channels;
applying a filler material to the open cooling channels; and
applying an outer wall about the internal skeleton having the filler material applied to the open cooling channels.

13. The blade of claim 12 wherein the internal skeleton comprises a superalloy.

14. The blade of claim 13 wherein the internal skeleton comprises at least one closed cooling channel.

15. The blade of claim 14 wherein the internal skeleton comprises more than one closed cooling channel.

16. The blade of claim 15 comprising drilling a plurality of cross-over holes between the open cooling channels and the closed cooling channels prior to applying the filler material.

17. The blade of claim 16 comprising an internal environmental coating applied to the internal skeleton prior to the application of the filler material.

18. The blade of claim 17 wherein the filler material is removed after the application of the outer wall.

19. The blade of claim 18 comprising an external environmental coating applied to the outer wall.

20. The blade of claim 19 wherein the internal skeleton and the outer wall comprise different superalloy materials.
